(19) United States
(12) Patent Application Publication
(10) Pub. No.: US 2013/0132122 A1
(43) Pub. Date: May 23, 2013

(54) SYSTEM AND METHOD FOR PROCESSING DATA RELATED TO EMPLOYER RETURN TO WORK PROGRAMS

(71) Applicants: Margaret E. Walsh, Plainville, CT (US); Sheila M. Wiatr, Avon, CT (US)

(72) Inventors: Margaret E. Walsh, Plainville, CT (US); Sheila M. Wiatr, Avon, CT (US)

(73) Assignee: HARTFORD FIRE INSURANCE COMPANY, Hartford, CT (US)

(21) Appl. No.: 13/298,583

(22) Filed: Nov. 17, 2011

(51) Int. Cl. G06Q 40/08

(52) U.S. Cl. 705/4

(57) ABSTRACT

A computer system for processing data related to return to work responsive to employee disability includes a return to work administration computer system, in communication via a network with user devices. The return to work administration computer system is configured to receive from the user devices, data related to employer return to work programs, including data indicative of designation of an individual employee to administer return to work programs, return to work policies, transitional job opportunities for employees to return to a workplace without resumption of full duties; access stored data indicative of business rules for comparing the received data related to employer return to work programs to benchmarks, and determine whether an employer has qualified for a benefit under a disability insurance policy issued to the employer.

### FIELD OF INVENTION

The present invention relates to computer systems, and particularly to computer systems for use in the financial services field, and particularly for processing of data related to employees and employers and to return to work programs for employees.

### BACKGROUND

Employers typically provide for coverage for their employees related to disabilities. In general, for an employee who is disabled, which is typically an inability of the employee to perform all the functions of his or her position, the employee is paid a periodic amount, which may be a percentage of the employee's salary. The payments thus provide income for the employee while the employee is disable and not receiving periodic paychecks. The payments are generally conditioned on expiration of an elimination period, and continuation of the disability. The coverage generally falls into short term disability, long term disability, and workers compensation categories. Short term disability coverage is for a disability that continues after an elimination period that is relatively brief, such as 15 or 30 days, and provides coverage for a period such as 90 or 120 days. If the employee remains disabled at the end of the period for short term disability, long term disability coverage is available. Long term disability coverage requires an elimination period, generally equal to the maximum period of short term disability coverage, such as 90 to 120 days, and continues for a longer period of time, such as one or two years from the date of disability. The continuation of long term coverage is contingent on continuation of the disability.

Workers compensation coverage is provided to provide income replacement for disabilities typically caused by injuries experienced on the job. Workers compensation is generally subject to a different regulatory environment from short term and long term disability, and is typically administered separately from short term and long term disability coverage.

In some cases, employers obtain insurance policies, which are issued to the employer, to provide both long term and short term disability coverage. Premiums charged for short term and long term disability coverage may differ for the same employer. Premiums may be calculated based on employee compensation, and on the risk of disability associate with a particular job. For example, the premium charged for a given amount of compensation, e.g., $1000, will typically be higher for a factory worker than for an office worker. Premiums may also be calculated based on claim experience for the industry and/or the particular employer, among other factors.

When an injury occurs, either the employer or the employee submits a claim under the employer's policy to the insurance company. The claim must be accompanied by appropriate documentation, such as statements by the employee, reports of treating physicians. The insurance company may collect additional information when evaluating a claim, such as by reviewing additional records, arranging for further medical examinations, and the like. Upon approval by the insurance company of a claim under such a policy, the insurance company makes payments to the employee for the appropriate short or long term coverage. The insurance company also typically reevaluates the disability, and may take steps to promote returning to work, such as arranging for rehabilitation services to treat the cause of the disability. In some instances, the employer may remain responsible for payments, such as for short-term disability coverage, but engage an insurance company to perform administrative services, such as evaluation of claims, review of approved claims and related services.

The definition of disability is dependent on the particular requirements of an employee's job. For example, a factory worker may be deemed disabled under a policy if an injury prevents the factory worker from performing physical activities on a daily basis. In contrast, the same injury suffered by an office worker may not result in the definition of disability being met. Alternatively, the factory worker may be able to perform less physically demanding duties while still recovering from the injury.

Systems that implement returns of employees to work, would reduce costs of insurance programs to employers and would be desirable at least for that reason.

### SUMMARY

In an embodiment, a computer system for processing data related to return to work after employee disability, includes a return to work administration computer system, in communication via a network with user devices. The return to work administration computer system is configured to: receive from the user devices data related to employer return to work programs, the data related to employer return to work programs comprising data indicative of designation of an individual employee to administer return to work programs, and at least one employer return to work policy. The return to work administration computer system is further configured to access stored data indicative of business rules for comparing the received data related to employer return to work programs to benchmarks, the benchmarks including at least: designation of at least one employee to administer return to work programs; adoption of at least one return to work policy meeting one or more requirements, and communication of the at least one return to work policy to employees. The return to work administration system is further configured to, responsive to determining, as a result of the comparison, that the benchmarks have been met, determine that the employer has qualified for a premium reduction for a portion of a term of the policy, and provide an output signal to an insurance premium billing system having data indicative of a result of the determination whether an employer has qualified for the premium reduction. The insurance premium billing system is configured to generate one or more bills to the employer based on the determination by the return to work administration computer system.

In an embodiment, a computer-implemented method for processing data related to employer return to work policies for return to work of employees after disability includes communicating by a return to work administration computer system via a network with user devices to receive from the user devices, data related to employer return to work programs. The data includes data indicative of designation of an individual employee to administer return to work programs and implementation of a return to work policy. The method further includes accessing by the return to work administration computer system from a data storage device stored data indicative of business rules for comparing the received data related to employer return to work programs to benchmarks, including designation of an individual employee to administer return to work programs, and adoption of a return to work policy. The method includes comparing the received data to the benchmarks, and based on the comparison, determining by the return to work administration computer system whether an employer has qualified for a benefit under an insurance policy issued to the employer; and providing an output signal by the return to work administration computer system to at least one of the user devices having data for display on the user device indicative of the determination as to qualification for the benefit.

In an embodiment, a non-transitory computer-readable medium has processor-executable instructions stored thereon relating to administration of insurance policies issued to employers and relating to employee disability, which instructions, when executed by the processor, cause the processor to: communicate via a network with user devices to receive from the plurality of user devices, data related to employer return to work programs, the data related to employer return to work programs including designation of an individual employee to administer return to work programs and adoption of a return to work policy; access from a data storage device stored data indicative of business rules for comparing the received data related to employer return to work programs to benchmarks; based on accessed the business rules and the accessed benchmarks, determine whether an employer has qualified for a benefit under an insurance policy, and provide an output signal to at least one of the user devices having data for display on the user device indicative of the determination as to qualification for the benefit.

### BRIEF DESCRIPTION OF DRAWINGS

FIG. 1 is a schematic diagram showing a computer system for administering return to work policies in an environment in which such a system may be implemented.

FIG. 2 is a schematic diagram of an exemplary computer system for implementation of a method and system of the invention, showing exemplary data fields.

FIG. 3 is a schematic diagram of an exemplary computer system and for implementation of a method and system of the invention.

FIG. 4 is a schematic diagram of an exemplary computer server, databases and networked devices for implementation of a method and system of the invention.

FIG. 5 is an exemplary schematic diagram of a system and a flow diagram of a method of an embodiment.

FIG. 6 is an exemplary screen shot of a screen provided by a system for implementing return to work programs.

FIG. 7 is an exemplary screen shot of a screen provided by a system for implementing return to work programs showing data related to return to work programs.

### DETAILED DESCRIPTION

It is to be understood that the figures and descriptions of the present invention have been simplified to illustrate elements that are relevant for a clear understanding of the present invention, while eliminating, for the purpose of clarity, many other elements found in typical computer systems and methods for processing of data relating to programs related to employee disability and to insurance policies, including insurance policies providing short term disability, long term disability and other coverage to employers. Those of ordinary skill in the art may recognize that other elements and/or steps are desirable and/or required in implementing the present invention. However, because such elements and steps are well known in the art, and because they do not facilitate a better understanding of the present invention, a discussion of such elements and steps is not provided herein.

Insurance company customers who have policies providing coverage relating to employee absence, such as short-term disability, and workers compensation coverage, may face challenges in connection with the return to work of absent employees. By way of example, an employee may have qualified for short term disability leave as a result of an injury that renders the employee unable to perform customary job duties. For employees whose customary duties involve physical activity, such as warehouse and factory employees, an injury may prevent a return to their customary duties until a complete recovery. However, such employees may be able to return to work in another capacity, such as in clerical duties, before a complete recovery. Alternatively, an employee in any job category may be able to return to work on a less than regular schedule, such as a schedule that permits absence from the workplace for rehabilitation therapy or medically needed rest. Similarly, for an employee in any job category, workplace accommodations, such as additional equipment or changes in duties to avoid physically demanding procedures, may permit the employee to return to work earlier than otherwise. Thus, a return to work in a modified job opportunity, which may include workplace accommodations or different job description, for example, may permit a disabled employee to return to work before resuming all job duties.

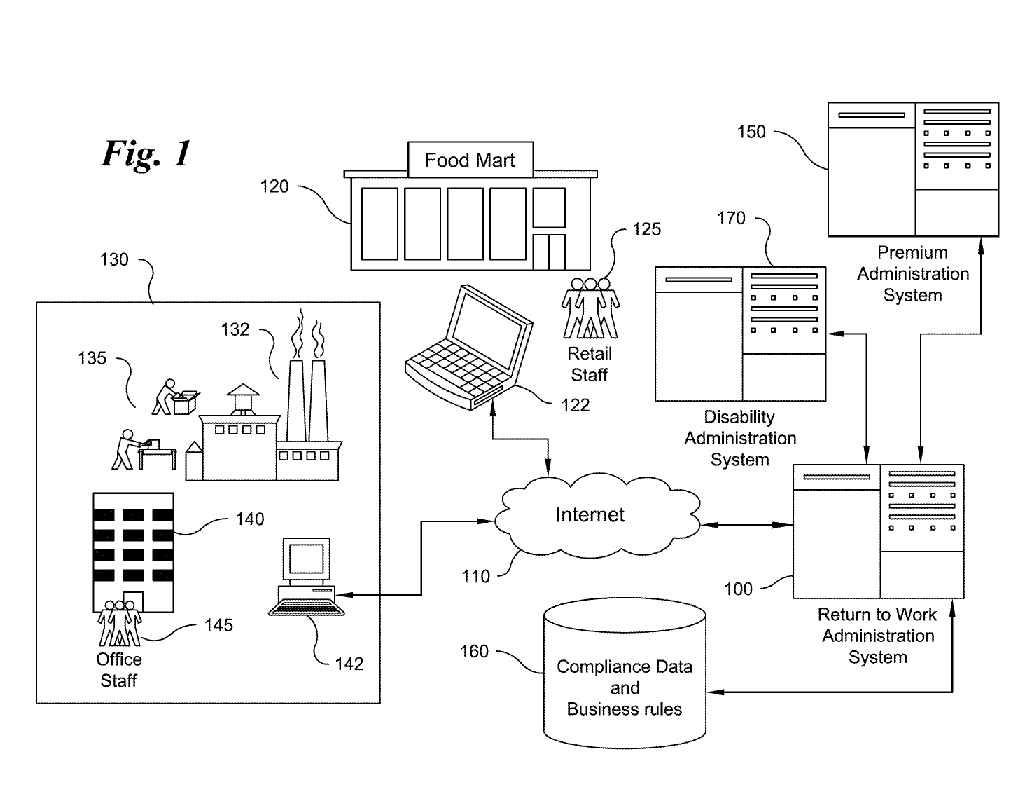

In an embodiment, a system according to the present invention facilitates return to work programs and activities of employers, thereby reducing the duration of employee absence due to disability, and thereby reducing the cost of claims and of premiums for insurance coverage such as short term disability coverage. Referring to FIG. 1, a return to work administration computer system 100 is associated with an insurance company. Return to work administration computer system 100 processes data associated with return to work programs, including accessing data from and writing data to business rules and compliance data store 160, communicating to premium billing computer system 150, also associated with the insurance company, at least data as to compliance of employers with requirements for premium pricing, and communicating with disability administration system 170, which is also associated with the insurance company. Return to work administration computer system 100 further communicates with employer computer systems 142, 122, data relating to return to work program data.

Still referring to FIG. 1, business rules data in data storage device 160 includes data reflective of obligations of employers in order to qualify for a premium discount, guaranteed premium rates, additional services, or other benefits associated with the insurance company associated with return to work administration computer system 100. By way of example, an insurance company may issue an employer a policy, such as a short term disability policy, for a term, with a premium set for a first portion of the term. Under the terms of the policy, conditioned on employer compliance with taking certain steps relating to return to work policies and practices during the first portion of the term, the premium rates may be reduced for the remaining portion of the term, or other benefits under that policy or under other policies issued by the insurance company may be provided to the employer. The system 100 may compare the employer's performance with stored benchmarks, such as requirements of designating an employee to coordinate return to work programs, and adopting a return to work policy having certain components, to determine whether the employer is eligible for the reduced premium rates or other benefits.

Business rules and compliance data store 160 may include data indicative of employers, insurance policies, and, with business rules in the nature of conditions to be met by an employer in order to qualify for a premium discount for a remainder of the policy term. In an embodiment, a single set of business rules may be stored and provide business rules for each of a plurality of employers to meet applicable conditions. In other embodiments, business rules and compliance data store 160 may include data indicative of multiple sets of business rules for compliance by different employers.

In an embodiment, the business rules may include conditions related to one or more of the following: return to work coordinator position filled, publication of return to work policy, distribution of employee information package to be used for return to work discussions with a medical provider; distribution of employee communications, management communications setting forth return to work program expectations; implementation of modified job opportunities, and other data.

Data relating to records of compliance may include data such as: as to a return to work coordinator, a date of hire, name and contact information for the individual, and listing of duties and reports of tasks performed, such as completion of policy documents, completion of training materials, conducting of employee training sessions, conducting of management training sessions, providing communications to attending physicians, and other activities. Data related to publication of return to work policy may include date of publication, manner of distribution (e.g., print copies, e-mail copies, posting on employer intranet, and other manners of distribution). Data relating to distribution of employee information package may include number of employees to receive the package, for example.

Still referring to FIG. 1, employer 120 is a retailer, and particularly a food store, and employer, having employees 125 who are retail staff. Retail staff 125 may be engaged in activities including clerical activities and customer service, and more physically demanding jobs such as cashier, shelf stocker, unloading delivery trucks and the like. Employer 120 has been issued an insurance policy by the insurance company associated with return to work administration system 100. Computer system 122 is an exemplary computer system associated with retail employer 120 and may be or include a laptop computer as shown. Via Internet 110, employer computer system 122 communicates with return to work administration system 100.

Employer 130 has both a factory location 132 having factory personnel 135 and office location 140 having office staff 145. Employer 120 has been issued an insurance policy by the insurance company associated with return to work administration system 100. Desktop computer system 142 of a computer system of employer 130 is in communication with return to work administration system 100. Authorized users may be provided access to data in data storage 160 via secure access, so as to obtain data relating to the status of return to work programs. For example, employer 130 may include in its return to work program opportunities for injured workers generally employed at factory location 132 to work in another capacity at office location 140 pending complete recovery. One or more application programs running on return to work administration system 100 may prompt authorized users at employers 120, 130 to provide data, such as periodic status reports as to the status of creation and communication of return to work policies. Furthermore, return to work administration system 100 may, responsive to contact from an authorized user associated with employers 120, 130 provide access to data relating to the status of the employer's current situation relative to benchmarks for being able to obtain reduced premiums or other benefits.

Disability system 170 may be configured to receive claims for short and long term disability benefits, or one of short and long term disability benefits, from employees, implement or assist with claims adjudication, monitor progress of employees after approval of a claim, and communicate data relating to claims to return to work administration system 100. Data provided by disability system 170 may be employed by return to work administration system 100 to generate analyses of claim history. For example, data such as average duration of claims, average costs of claims may be calculated for periods prior to and after implementation of return to work policies by an employer, and comparisons generated to determine whether employers are experiencing improvement in reducing claims costs and absence caused by disabilities.

Disability system 170 may also be configured to pass data concerning individual employees to return to work administration system 100 to facilitate application of rules by return to work administration system 100 with respect to accelerating return to work of employees. For example, return to work administration system 100 may have rules regarding types of jobs and types of injuries, and related job modifications. For example, for a particular injury and particular job description, one or more workplace accommodations or alternative jobs may be identified by return to work administration system 100, and returned to employer devices for action by employers in implementing the recommended workplace accommodations or alternative jobs.

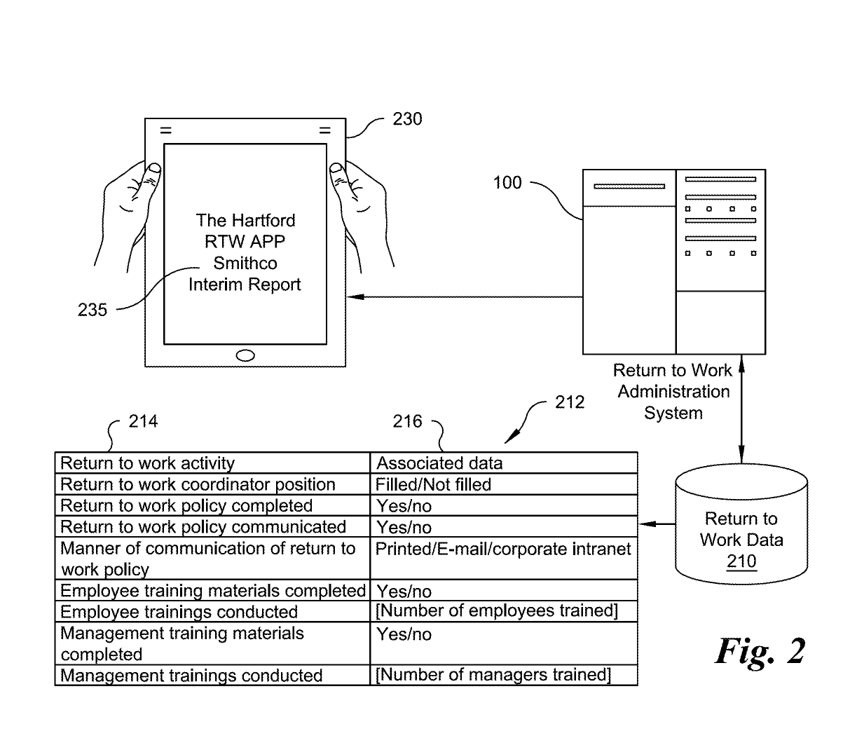

Referring to FIG. 2, an exemplary environment is shown in which return to work administration system 100 communicates with a database 210 having return to work data. Table 212 illustrates data stored in database 210 and accessed by and updated by return to work administration system 100. Column 214 in table 212 illustrates categories of return to work activity, such as return to work coordinator position, return to work policy completion, and the like. Column 216 illustrates the corresponding available data, such as a value of yes or no corresponding to whether an employer's return to work policy has been completed. The values include binary values, such as yes/no or filled/not filled, multiple values, such as printed, e-mail or corporate intranet as to manner of distribution of a return to work policy, and numerical values, such as numbers of employees trained or numbers of managers trained. These values are exemplary. For example, numerical values may be assigned based on one or more algorithms as to a return to work policy, such as a sum of point values assigned by system 100 or by a human operator associated with the insurance company for such factors as quality of return to work policy, timeliness of completion of the policy, effectiveness of distribution, and number and effectiveness of training sessions related to the policy.

Still referring to FIG. 2, tablet computer system 230 illustrates an initial screen 235 of an application program running on tablet computer system 230 and configured to communicate with system 100 and data storage 210, and to display data related to return to work programs of an employer. Tablet computer system 230 may store data related to return to work program benchmarks, and data received from employers, locally, or may access data from data storage 210. Tablet computer system 230 may be configured with instructions for performing analytics, such as comparisons of benchmarks with current data, and presenting the results of analyses in one or more displays. In an embodiment, tablet computer systems 230 may be configured with applications for employer representatives to access and analyze data relating to employer progress in implementing return to work programs, as well as statistics relating to history of short term disability and long term disability claims of the employers. Only the data of that particular employer will be available to the employer, although statistical data for industry and regional peers may be available for comparison purposes. In an embodiment, available applications may include applications accessible by employees to determine possible workplace modifications and other modified job duties applicable to their situations. For example, an employee may have a secure log in, view their information in the system, and receive recommendations of possible workplace modifications. An employee may also have the opportunity to transmit such recommendations to an employer computer system.

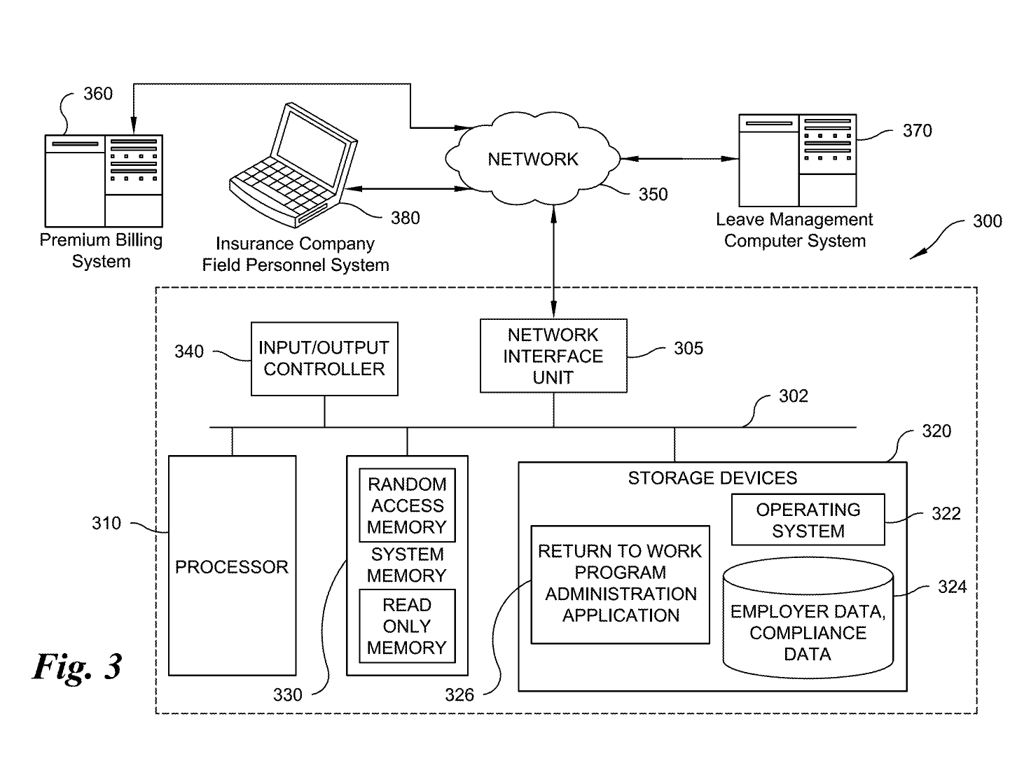

Referring to FIG. 3 an exemplary computer system 300 for use in an implementation of the invention will now be described. In computer system 300, processor 310 executes instructions contained in programs such as return to work program administration application program 326, stored in storage devices 320. Return to work program administration application program may include separate modules for such functions as prompting employer users for data, evaluating employer compliance with program requirements, administering job description data, and administering a library of forms. Storage devices 320 may include suitable non-transitory computer-readable media, such as optical or magnetic disks, fixed disks with magnetic storage (hard drives), flash memory, tapes accessed by tape drives, and other storage media. Processor 310 communicates, such as through bus 302 and/or other data channels, with network interface unit 305, system memory 330, storage devices 320 and input/output controller 340. Via input/output controller 340, processor 310 may receive data from user inputs such as pointing devices (including mice and trackballs), touch screens, audio inputs and keyboards, and may provide data to outputs, such as data to video drivers for formatting on displays, data to print drivers for transmission for printing in hard copy or to image files, and data to audio devices.

Storage devices 320 are configured to exchange data with processor 310, and may store programs containing processor-executable instructions, including instructions for implementing calculations employing algorithms, such as algorithms for determining compliance of employers with return to work program benchmarks, and values of variables for use by such programs. Processor 310 is configured to perform steps in accordance with such processor-executable instructions. Processor 310 is configured to access data from storage devices 320, which may include connecting to storage devices 320 and obtaining data or reading data from the storage devices, or placing data into the storage devices 320. Storage devices 320 may include local and network accessible mass storage devices. Storage devices 320 may include media for storing operating system 322 and mass storage devices such as employer data and compliance data storage device 324 for storing data related to employers, return to work policies and compliance with benchmarks. Such data may include data regarding return to work policies, reporting requirements, schedule for assessments or visits by insurance company personnel and records of such visit, publicizing of return to work policies to employees and management of policies, potential job accommodations, potential work alternatives such as working from home, job sharing and flexible work schedules, and other data.

In an embodiment, inputs may include user interfaces, including workstations having keyboards, touch screens, pointing devices such as mice and trackballs, or other user input devices, connected via networked communications to processor 310. Network interface unit 305 may communicate via network 350 with other insurance computer systems, such as premium billing system 360 for generating premium bills and sending premium bills to insured employers. The premium billing system 360 may be configured to generate bills either with or without discounts responsive to data received from processor 310.

Network interface unit 305 may further communicate with computer systems of employers and insurance companies, such as absence/leave management computer system 370. Absence/leave management computer system 370 may be configured for various tasks related to claims for absence from work, such as claims for one or more of short term disability, long term disability, workers compensation, family and medical leave, maternity leave, military active duty leave, and other types of leave. System 370 may be configured for evaluation of data related to claims, determinations of whether an employee is eligible, and furnishing data to system 300 responsive to a determination that an employee is eligible for leave related to disability. System 370 may be configured to administer multiple types of employee leave policies. System 370 may be configured to provide automated claim intake for a variety of possible leave claims via web interfaces, interactive voice response systems and other systems, compare submitted data to requirements for leave of various types, request additional data needed to evaluate claims, make determinations of claim approval or denial, arrange for periodic review of claims, referral to medical interventions such as physical therapy or other treatment for disability related claims, and generally to follow a case until the employee returns to work or the case is otherwise terminated, such as by expiration of a maximum benefit period.

Responsive to receipt from absence/leave management computer system 370 of data indicative of an approved claim for disability, system 300 may receive and store the data and execute algorithms related to determining a time and nature of any accommodation to return the employee to work prior to complete recovery of ability to perform normal duties. System 300 may communicate via network 350 with insurance company field personnel system 380, which may be configured to prompt insurance company field personnel to input data related to return to work programs while on site visits to employer locations. The network interface unit 305 may further communicate with computer systems of employers, employees who are on leave or have returned to work as part of a return to work program, and other exemplary systems not shown in FIG. 3, such as web servers, systems for issuing policies, systems for generation of policy documents for delivery to employers and for generation of documents for employees, medical practitioners and others related to disability claims and return to work, systems for administration of collections of premiums due to an insurer, systems of brokers and agents, computer systems of banks and other financial institutions that effect payments of premiums under the policies and payments of claims under the policies, and remote sources of data.

In other embodiments, one or more of the functions of other systems may be incorporated in the functionality of computer system 300. By way of example, computer system 300 may be configured both for administration of return to work programs and generation of documents related to the return to work programs, intake and other administration of claims, either in connection with a leave management computer system, a short term disability claim administration computer system or alone, and other functions. Network 350 may be or include wired or wireless local area networks and wide area networks, and over communications between networks, including over the Internet. Any suitable data and communication protocols may be employed.

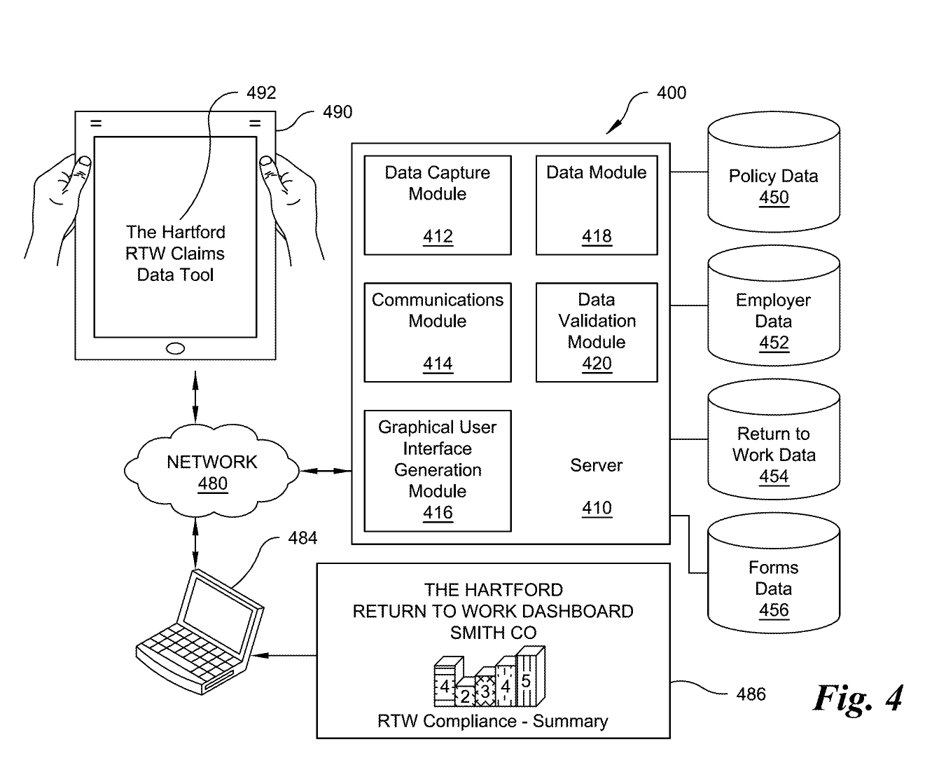

Referring now to FIG. 4, another exemplary embodiment of a system 400 of the present invention is shown. System 400 includes an insurance company hardware server 410 which includes one or more engines or modules which may be utilized to perform one or more steps or functions of embodiments of the present invention. In an embodiment, the present invention is implemented as one or more modules of a computer software program in combination with one or more components of hardware. Such software programs will be used generally where an employer representative, employee claimant for benefits, medical practitioner providing services to such an employee, insurance company employee or other representative, has sent a request for data or information to a server and comprises part of the processing done on the server side of the network. The programs may be used in an Internet environment, where the server is a Web server and the request is formatted using HTTP (or HTTPS). Alternatively, the server may be in a corporate intranet, and extranet, or any other type of network. Use of the term “Internet” herein, when discussing processing associated with the user's request, includes these other network environments, unless otherwise stated. Additionally, a graphical user interface or other module may be implemented as an intelligent hardware component incorporating circuitry including custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like. One or more functions of a web client or other module may be implemented as application software in the form of a set of processor-executable instructions stored in a memory of a client device, such as tablet computer 490 or laptop 484, and capable of being accessed and executed by a processor of the client device.

Referring still to FIG. 4, server 410 includes a data capture or input/output module 415, a communications module 420, a dynamic display generation or graphical user interface module 425, a data module 430, and a data validation module 435. Data module 430 is in further communication with a number of databases such as insurance policy database 450, employer database 452, return to work database 454 and forms database 456. Databases 450, 452, 454, 456 may be implemented in one or more physical data storage devices in communication with server 410, or may be implemented in remote data storage devices accessible over one or more networks, such as cloud computer servers accessible via the Internet. Databases in communication with server 410 may include both internal and/or external/third party databases. By way of example, external databases may include databases of financial services entities containing information relating to funds available for payment of premiums, data accessed via social networks relating to individual employees of covered employers, whether claimants or others, for verification or contradicting reports made by employers, and other data. Server 410 may be configured for bulk upload of data for use in administration of return to work programs, such as data related to employees who have made claims for disability, workers compensation or other coverage. Such data may be furnished such as via a spreadsheet file or via suitable xml documents, by way of example. Such data may be contained in one or more legacy systems, such as a short term disability administration system, that communicate with system 400 via suitable middleware systems. One or more modules may be configured to perform data validation steps prior to storing bulk uploaded data. Server 410 may further be configured to permit bulk download of data, such as return to work data for an employer, to a device of suitably-authorized user.

In operation, server 410 is in communication with client devices, such as laptop computer 484 or tablet computer 490 via network 480 which facilitates interaction with server 410 through one or more graphical user interfaces as shown and described herein. As used herein, devices, such as client devices 484, 490 may exchange information via any communication network, such as a Local Area Network (LAN), a Metropolitan Area Network (MAN), a Wide Area Network (WAN), a proprietary network, a Public Switched Telephone Network (PSTN), a Wireless Application Protocol (WAP) network, a Bluetooth network, a wireless LAN network, and/or an Internet Protocol (IP) network such as the Internet, an intranet, or an extranet. Note that any devices described herein may communicate via one or more such communication networks.

Referring still to FIG. 4, utilizing client devices 484, 490, a properly authenticated system user, such as an insurance company representative, employee/claimant, or employer representative, may view or update return to work related data. By way of example, display 492 may be provided of a return to work field data tool, in the form of an application program running on tablet computer 490. The field data tool may be configured to prompt an insurance company user to input data on a site visit to an employer location. Such data may include data for a work site visit that may include prompts to indicate common possible accommodations, such as implementing breaks, removing physically demanding activities such as lifting objects above a threshold weight from a job description, adding assistive devices to the workplace area, and other accommodations. The field data tool may be employed in connection with particular employees. For example, the field data tool may be employed at meetings with employer representatives, claimants and healthcare providers to record approvals of modified work assignments. Data related to the modified work assignments may be uploaded to server 410 and then to return to work database 454. Subsequently, server 410 may generate prompts to the employer representative to review and verify compliance with the agreed modified work assignment, including verifying accommodations. The field tool may be configured to prompt the user to upload digital photographs showing equipment implemented as part of an accommodation, for example. Server 410 may further generate prompts to the employee to confirm that the accommodation is being adhered to, such as by sending electronic messages, such as texts or e-mails, to the employee, and requesting a reply.

By way of further example, the server 410 may be configured to generate and display dashboard 486 on laptop 484 to a suitably authenticated user, such as an employer representative. The dashboard may include a graphical representation of progress toward meeting benchmarks in 5 categories, such as completion of policy, number of returns to work under the program, numbers of employer accommodations, number of employee training programs, number of management training programs, and other possible benchmarks.

A properly authenticated individual, such as an employee of an insurance company having administrative responsibilities, may access further data and provide updates and modifications to modules, updates of business rules, and other modifications. In embodiments the present invention, one or more of the above modules, may also be implemented in combinations of software and hardware for execution by various types of computer processors coupled to such hardware.

As used herein, a module of executable code may, for instance, comprise one or more physical or logical blocks of computer instructions which may, for instance, be organized as an object, procedure, process or function. Nevertheless, the executables of an identified module need not be physically located together, but may comprise separate instructions stored in different locations which, when joined logically together, define the module and achieve the stated purpose for the module such as implementing the business rules logic prescribed by the present system. In embodiments of the present invention a module of executable code may be a compilation of many instructions, and may be distributed over two or more different code partitions or segments, among different programs, and across two or more devices. Similarly, data, including by way of example employer data, claim data and return to work data may be identified and illustrated herein within modules, and may be embodied in any suitable form and organized within any suitable type of data structure. Such data may be collected as a single data set, or may be distributed over different locations including over different storage devices, and may exist, at least partially, merely as electronic signals on a system and/or network as shown and described herein.

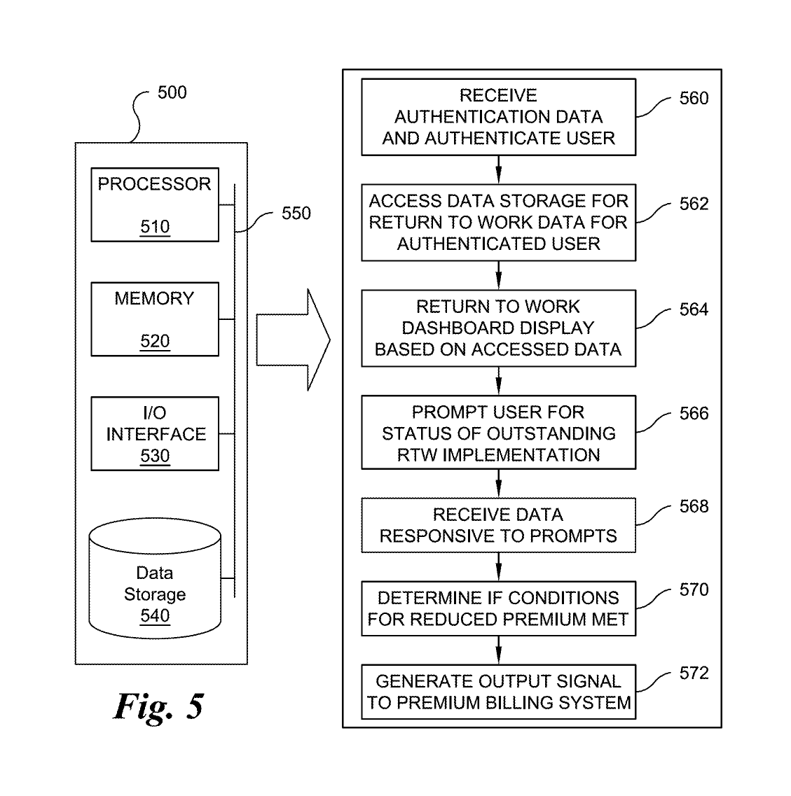

Referring to FIG. 5, in an embodiment, a computer server or client computer 500 running a client application such as a Web browser or a thick client application renders a graphical user interface, such as a series of screens to permit a user, such as an employer representative or insurance company representative, to view data related to return to work program implementation, such as implementation of policies, status of specific claimants eligible for return to work, applicable locations and loss units, occupations, related vendors such as healthcare providers, occupational health services providers, employee assistance providers and workers compensation coverage providers, job descriptions, contact information for various involved individuals, and other data. The graphical user interface may also include input screens to permit a user to provide input data to confirm the status of return to work initiatives, specific workplace accommodations, and initiate new return to work programs. Server or client computer 500 may include a processor 510, e.g. CPU, memory 520, I/O interface 530 and a storage mechanism 540 coupled together via a system bus 550 over which the various elements may interchange data and information. Computer 500 implements steps 560-572 in accordance with embodiments of the present invention.

Still referring to FIG. 5, computer 500 receives 560 authentication information from an authorized user, such as an employer representative, employee/claimant, or insurance company representative, and authenticates the user. Computer 500 may by default access 562 data from data storage 540 associated with the authorized user, such as, for an employee, a return to work plan and associated data, or a return to work implementation program for an employer representative, and present an initial screen with data suitable for the particular user. The system may also access other systems, such as leave management systems, to verify the status of claim processing. The system may obtain from a leave management system data indicative of whether or not a response from an employee or an employer is needed relating to a claim, such as additional data regarding a location of an incident resulting in injury, or other data. The data accessed and presented on the initial screen and subsequent screens, as well as the available functions, depends on the identity and role of the authorized user; rules may be stored in data storage 540 and accessed by processor 510 to determine the available data and functions. For example, for an authorized user such as an employer representative, listings of progress against benchmarks may be shown, or alerts indicative of requests for data from the leave management system that have not been responded to. The initial screen may include links and tabs to permit the user to access additional information, such as additional information relating to a claim in a leave management system, a return to work program for a particular employee, or an overall company or site return to work program, which may be in dashboard format 564. The initial screen may also include a listing of one or more messages or alerts in accordance with business rules, such as upcoming dates for scheduled meetings with insurance company personnel, due dates for submission of documentation of publication of policies, implementation of training, or unresolved requests for information from a leave management system. The initial screen or a later screen may prompt 566 the user for data related to return to work programs, such as data responsive to alerts.

The computer 500 may receive data indicative of a change in return to work programs or changes in workplace accommodations, hours, duties or other matters with respect to an employee in a return to work program 568. Responsive to the request, the computer 500 may access business rules and determine 570 whether the employer has met requirements for a reduction in premium. An output signal may be provided 570 by system 500 to a premium billing system to reduce or to maintain premium billing rates depending on the results of the review.

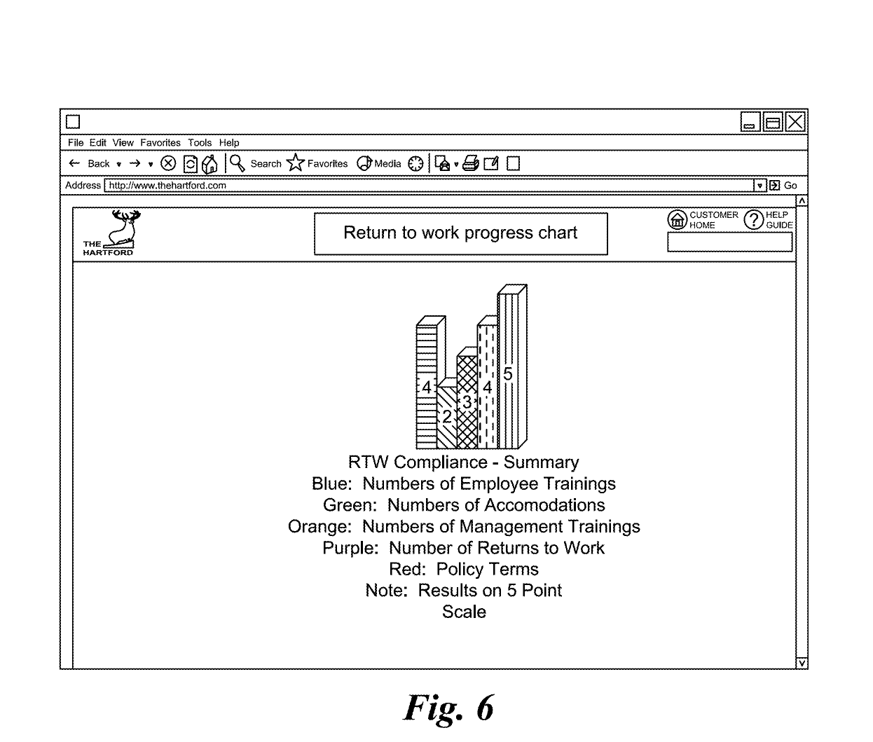

Referring to FIG. 6, an exemplary display indicative of progress on implementation of a return to work policy is shown. Such a display may be generated by return to work administration system 300 of FIG. 3 for display on a user device. In FIG. 6, a display is shown of five categories of progress. The categories are completion of policy, number of returns to work under the program, numbers of employer accommodations, number of employee training programs, number of management training programs. The display shows the categories on a normalized scale. Thus, the policy completion benchmark has been met to qualify for a premium reduction. Other benchmarks require additional performance.

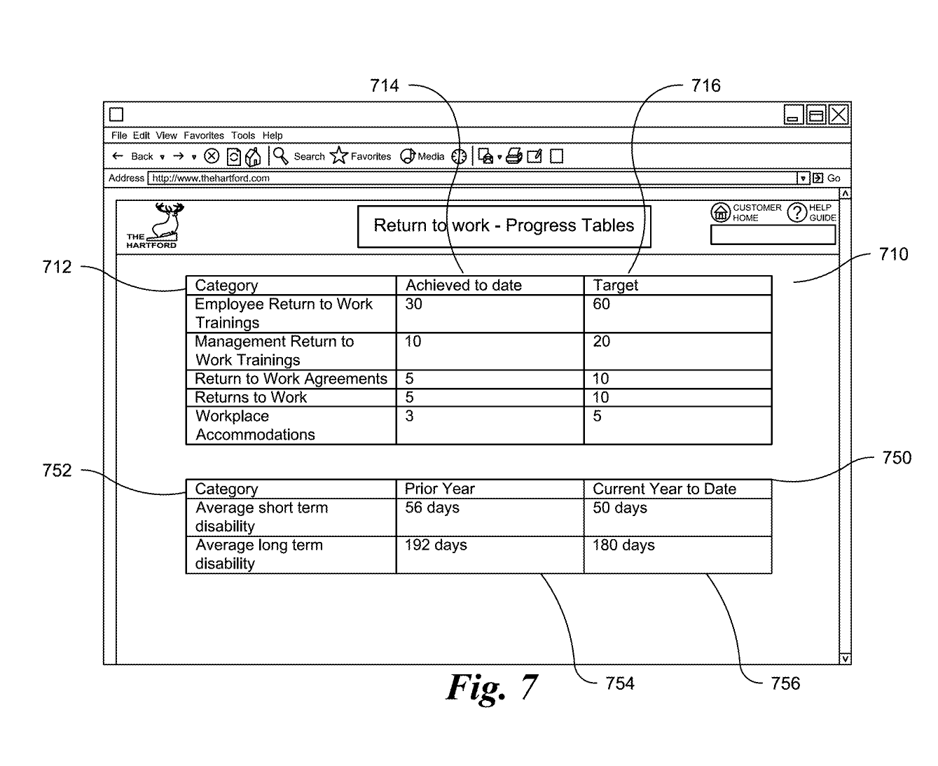

Referring to FIG. 7, examples of charts showing categories of performance, completed numbers, and a target to be completed by a target date to qualify for benefits is shown. Chart 710 shows categories 712 of return to work implementation data to date 714, such as numbers of training sessions, as compared to a target 716. The target may be a target agreed by the insurance company and the employer for a reduction in premium for a portion of a policy term, for example. Chart 750 shows data related to categories 752 of disabilities, prior term results 754 and current results 756. Theses data may be used to show the cost savings associated with implementation of a return to work policy. The data may be displayed on a user device and accessed from a return to work administration system. The user can see graphically progress toward the goal.

Referring again to FIG. 4, forms data 456 may include a library of forms available for use by employers. Employers may have authority to upload forms developed in their own systems, be prompted to enter sufficient data to classify the forms, such as by categories as policy, notification to employee of opportunity to participate in the RTW program, form of RTW program agreement, and other categories. The forms may be accessible to other employers for use, and may be retrieved responsive to suitable search queries. Designation of values for various fields in a relational database may be accomplished by an uploading employer, by insurance company personnel, or both, and may be supplemented or replaced by program logic that reviews the wording in forms and suggests or designates suitable values of fields. The forms database may be added to by employers, thereby creating a suitable resource.

Similarly, a jobs database may be established and supplemented with new job descriptions added by employers. The jobs database may include possible accommodations for individuals in various types of jobs, as added by employers to the database using suitable tools.

Premium calculations may be based on salary and occupation, hourly wage and occupation, and other factors known in the industry and later developed. Discounts may be implemented, such as percentage discounts in the range of 1% to 10% of annual premiums, based on compliance with return to work policy implementation.

The leave management system 370 of FIG. 3 may be configured to receive data related to a new employee leave at a single point of contact. The single point of contact may be implemented as a single address for leave issues related to any type of leave, including for example for employment-related injuries compensated through workers compensation, short term disability, long-term disability, family illness, child bonding, military exigencies, volunteer services, and other types of leave. The single point of contact may be implemented in various modes of communication, such as a single telephone number for intake for different types of leave, a single web address or other resource accessible from a browser for different types of leave, a single fax number, and other contact points. The leave management system may be configured to provide prompts to a user for claims relating to multiple types of leave. The leave management system may be configured to furnish data to the return to work computer system, as well as to systems for administration of particular types of leave, such as systems for administering short term disability claims and workers compensation claims. The leave management system may be configured to administer one or more different types of leave. The leave management system may be configured to track and report leave under employer policies and union contracts, such as vacation, personal time and sick time leave, in addition to or as an alternative to legally mandated leave. The leave management system may be configured to administer one or more benefits, such as wage replacement benefits, permanency benefits, death benefits and medical expenses related to an injury for workers compensation leave. The leave management system may further be configured to administer investigation, adjudication, management and resolution of a claim and costs associated with investigation, adjudication, management and resolution of a claim. The leave management system may be configured to furnish data to the return to work administrative system at any appropriate time in the processing of claims, such as upon approval of a claim, denial of a claim, or in the event of a lack of required response from an employer, employee or medical provider related to a claim.

A processor may provide the central processing unit (CPU) functions of a computing device on one or more integrated circuits. The term “processor” may include multi-core processors and central processing units including multiple microprocessors. The central processing unit functionality may be provided at one or more remote locations, such as through application service provider and cloud computing services.

In embodiments, a processor may provide an output signal having data indicative of one or more data items. An output signal may be carried either over a suitable medium, such as wire or fiber, or wirelessly. An output signal may transmit data from one device to another directly, such as over a bus of a computer system from a processor to a memory device, or indirectly, such as over multiple networks, and with intermediate steps of storage in a buffer or memory device and retransmission. Such an output signal may be provided by the processor to a bus of a computer system together with address data at a series of clock intervals. The address data may designate a destination device on a bus, by way of example. In embodiments, an output signal may be a signal output from a hardware communications device of a computer system to a network, such as a local area network, a wide area network, or a network of interconnected networks, such as the Internet. Output signals may include, by way of example, data identifying formats, fields, and content of fields. Signals may be compatible with any appropriate format. For example, data may be formatted in accordance with a data format for insurance data, such as an ACORD compatible format, or a non-ACORD xml format. Reference to an output signal having particular data may include one or more signals bearing the information. Multiple signals bearing the information may include sequences of digital data bearing the information interleaved with sequences of digital data relating to other information. By way of example, a signal may be packetized for transmission. By way of further example, an output signal may take the form of an uncompressed digital signal or a compressed digital signal.

A system on which the methods of embodiments of the present invention may be implemented includes at least one central processing computer or computer network server. A network server includes at least one controller or central processing unit (CPU or processor), at least one communication port or hub, at least one random access memory (RAM), at least one read-only memory (ROM) and one or more databases or data storage devices. All of these later elements are in communication with the CPU to facilitate the operation of the network server. The network server may be configured in many different ways. For example, a network server may be a standalone server computer or alternatively, the functions of a network server may be distributed across multiple computing systems and architectures.

A network server may also be configured in a distributed architecture, wherein databases and processors are housed in separate units or locations. Some such servers perform primary processing functions and contain at a minimum, a RAM, a ROM, and a general controller or processor. In such an embodiment, each of these servers is attached to a communications hub or port that serves as a primary communication link with other servers, client or user computers and other related devices. The communications hub or port may have minimal processing capability itself, serving primarily as a communications router. A variety of communications protocols may be part of the system, including but not limited to: Ethernet, SAP, SAS™, ATP, Bluetooth, GSM and TCP/IP.

Data storage device may include hard magnetic disk drives, optical storage units, CD-ROM drives, or flash memory, by way of example. Data storage devices contain databases used in processing calculations embodied in algorithms, including data for display on client devices and data for determination of compliance with requirements to obtain reduced premiums or other benefits. In one embodiment, database software creates and manages these databases. Insurance related calculations and/or algorithms in accordance with an embodiment of the present invention may be stored in storage devices and accessed and executed by a processor.

Suitable computer program code may be provided for performing numerous functions such as producing reports indicative of experience, including numbers of returns to work implemented, cost savings of same, days of short term disability or long term disability saved, providing surveys to employees, managers, and others relating to satisfaction and success of return to work policies, processing of data received from other computer systems and from system users, and other functionality. The functions described above are merely exemplary and should not be considered exhaustive of the type of function which may be performed by the computer program code of embodiments of the present inventions.

The computer program code required to implement the above functions (and the other functions described herein) can be developed by a person of ordinary skill in the art, and is not described in detail herein.

A computing system may include modules, which may be implemented in hardware, software, or combinations of software and hardware, operably inter-connected via a bi-direction al connection with a central serial bus or other bus. A system may include a display module and a generating module. The generating module is used for generating policy contracts, service level agreements, forms, reports and other documents, which documents are then delivered to employers, employees, and others, via any suitable hard copy or electronic method.

The computing system may be in communication with one or more payment systems for effecting payments under claims to employees, and may be configured to provide data indicative that payments under a disability claim are to be ceased or reduced during return to work activities.

The term “computer-readable medium” as used herein refers to any medium that provides or participates in providing instructions to the processor of the computing device (or any other processor of a device described herein) for execution. Such a medium may take many forms, including but not limited to, non-volatile media, non-transitory media, tangible media, volatile media, and transmission media. Non-volatile media and tangible media include, for example, optical or magnetic disks, such as memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, a carrier wave as described hereinafter, or any other medium from which a computer can read.

Various forms of computer readable media may be involved in carrying one or more sequences of one or more instructions to the processor (or any other processor of a device described herein) for execution. For example, the instructions may initially be borne on a magnetic disk of a remote computer. The remote computer can load the instructions into its dynamic memory and send the instructions over an Ethernet connection, cable line, or even telephone line using a modem. A communications device local to a computing device (or, e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

Servers of embodiments of the present invention may also interact and/or control one or more user devices or terminals. The user device or terminal may include any one or a combination of a personal computer, a mouse, a keyboard, a computer display, a touch screen, LCD, voice recognition software, or other generally represented by input/output devices required to implement the above functionality. The program also may include program elements such as an operating system, a database management system and “device drivers” that allow the processor to interface with computer peripheral devices (e.g., a video display, a keyboard, a computer mouse, etc).

An exemplary advantage of a method and system of the present invention is that return to work program implementation is facilitated, with the potential for reducing duration of disability, costs of disability claims and premiums for disability coverage.

While particular embodiments of the invention have been illustrated and described, various modifications and combinations can be made without departing from the spirit and scope of the invention, and all such modifications, combinations, and equivalents are intended to be covered and claimed.

What is claimed is:

1. A computer system for processing data related to return to work after employee disability, comprising:
a return to work administration computer system, in communication via a network with a plurality of user devices, the return to work administration computer system configured to: receive from the plurality of user devices data related to employer return to work programs, the data related to employer return to work programs comprising data indicative of designation of an individual employee to administer return to work programs, and at least one employer return to work policy;
access stored data indicative of business rules for comparing the received data related to employer return to work programs to benchmarks, the benchmarks including at least: designation of at least one employee to administer return to work programs; adoption of at least one return to work policy meeting one or more requirements, and communication of the at least one return to work policy to employees;
responsive to determining, as a result of the comparison, that the benchmarks have been met, determine that the employer has qualified for a premium reduction for a portion of a term of the policy; and
provide an output signal to an insurance premium billing system having data indicative of a result of the determination whether an employer has qualified for the premium reduction; and
the insurance premium billing system configured to generate one or more bills to the employer based on the determination by the return to work administration computer system.

2. The computer system of claim 1, further comprising a data storage device in communication with the return to work administration computer system, the data storage device storing data indicative of a plurality of form documents for use by employers in connection with return to work policies.

3. The computer system of claim 2, wherein the return to work administration computer system is further configured to receive documents from employer devices and make received documents available for access from employer devices.

4. The computer system of claim 1, wherein the data indicative of business rules comprises data indicative of return to work policy implementation conditions, which, when met by a target date, cause the employer to be eligible for premium discount for a policy term after the target date.

5. The computer system of claim 4, further comprising a short term disability insurance computer system in communication with the return to work administration computer system, the short term disability insurance computer system being configured to notify the return to work administration computer system upon approval of a claim for short term disability benefits.

6. The computer system of claim 4, wherein the return to work policy implementation conditions further comprise: designation of individual employees to serve as return to work coordinators; and development of transitional job opportunities.

7. The computer system of claim 4, wherein the return to work administration computer system is further configured to make available to the user devices displays having data indicative of progress to achieving benchmarks in a plurality of categories.

8. The computer system of claim 1, further comprising a leave management system in communication with the return to work administration computer system, the leave management system being configured to receive and adjudicate claims, and responsive to approval of a claim, provide a notification to the return to work administration computer system of the approved claim.

9. The computer system of claim 1, wherein the data related to employer return to work programs further comprises data related to return to modified job opportunities for employees returning to work.

10. A computer-implemented method for processing data related to return to work after employee disability, comprising:
communicating by a return to work administration computer system via a network with a plurality of user devices to receive from the plurality of user devices, data related to employer return to work programs, the data related to employer return to work programs comprising data indicative of designation of an employee to administer return to work programs, and at least one return to work policy;
accessing by the return to work administration computer system from a data storage device stored data indicative of business rules for comparing the received data related to employer return to work programs to benchmarks, the benchmarks including designation of an individual employee to administer return to work programs, and implementation of a return to work policy;
based on comparing the received data with the business rules, determining by the return to work administration computer system whether an employer has qualified for a benefit under an employee disability insurance policy issued to the employer; and
providing an output signal by the return to work administration computer system to at least one of the user devices having data for display on the user device indicative of the determination as to qualification for the benefit.

11. The computer-implemented method of claim 10, wherein the benefit comprises a reduction in premium and further comprising:
providing by the return to work administration computer system to an insurance premium billing system data indicative of qualification for the premium reduction; and
generating by the insurance premium billing system one or more bills to the employer implementing the premium reduction.

12. The computer-implemented method of claim 10, wherein the data related to employer return to work programs further comprises data indicative of return to work policy publicizing and return to work training.

13. The computer-implemented method of claim 10, further comprising prompting a user at a user device to input data related to return to work program implementation, and transmitting the data from the user device to the return to work administration computer system.

14. The computer-implemented method of claim 10, further comprising receiving data indicative of an agreed modified work assignment with respect to an employee.

15. The computer-implemented method of claim 14, further comprising causing a user device to prompt an employer representative to review and verify compliance with the agreed modified work assignment.

16. The computer-implemented method of claim 15, further comprising administering a library of forms related to return to work policies.

17. A non-transitory computer-readable medium, the computer-readable medium having processor-executable instructions stored thereon relating to administration of insurance policies issued to employers and relating to employee disability, which instructions, when executed by the processor, cause the processor to:
communicate via a network with a plurality of user devices to receive from the plurality of user devices, data related to employer return to work programs, the data related to employer return to work programs comprising data indicative of designation of an employee to administer a return to work program, and adoption of a return to work policy;
access from a data storage device stored data indicative of business rules for comparing the received data related to employer return to work programs to benchmarks, the benchmarks including designation of an employee to administer a return to work program, and adoption of a return to work policy;
based on accessed the business rules and the accessed benchmarks, determine whether an employer has qualified for a benefit under one of the policies; and
provide an output signal to at least one of the user devices having data for display on the user device indicative of the determination as to qualification for the benefit.

18. The non-transitory computer-readable medium of claim 17, wherein the instructions further cause the processor to:
provide data to the user devices to display alerts indicative of requests for data from a leave management system that have not been responded to.

19. The non-transitory computer-readable medium of claim 17, wherein the instructions further cause the processor to:
administer a database of job descriptions, the job descriptions being available for access by employers via the user devices.

20. The non-transitory computer-readable medium of claim 19, wherein the job descriptions include data indicative of possible accommodations for at least some of the job descriptions.

21. The non-transitory computer-readable medium of claim 17, wherein the instructions further cause the processor to format and output a dashboard display of data related to return to work implementation for display on one of the user devices.
